(19) United States
(12) Patent Application Publication
(10) Pub. No.: US 2020/0134541 A1
(43) Pub. Date: Apr. 30, 2020

(54) TEAM MATCHING SYSTEM

(71) Applicant: SAP PORTALS ISRAEL LTD., Ra'anana (IL)

(72) Inventors: Rachel Ebner, Ra'anana (IL); Evgeny Himmelreich, Lapid (IL); Nirit Cohen-Zur, Ra'anana (IL); Itai Fonio, Tel Aviv (IL); Asher Kirshenbaum, Kefar Sava (IL); Edna Tamir-Dahan, Even-Yehuda (IL); Shira Woolf, Maor (IL)

(21) Appl. No.: 16/176,520

(22) Filed: Oct. 31, 2018

(51) Int. Cl. G06Q 10/06; G06N 99/00

(52) U.S. Cl. CPC G06Q 10/063118; G06F 3/04842; G06N 99/005

(57) ABSTRACT

Methods and systems are used for determining new teams. Personality data associated with one or more individuals is received. The personality data is used to select a candidate from the one or more individuals for placement on a new team associated with a project or to match the candidate to an existing team. Performance data for one or more existing teams on one or more existing projects is received. Team preference data is received that identifies an importance value associated with each team aspect of one or more team aspects used in a determination of the new team or for the existing team. A new team for the project or an update to the existing team is determined using machine learning and based on the personality data, the performance data, and the team preference data.

### BACKGROUND

Building a team for a project can include various challenges. A manager or a recruiter can evaluate the personalities and matches of potential team members in various ways. If time is not a constraint, then the manager can identify a person with the right skills for a particular project. If the manager does not know the candidate, the candidate can be interviewed to develop an impression of the candidate's personality. Other ways of obtaining information about a candidate include expensive tests, personality profiles, and recommendations. Using obtained information, the manager can estimate which particular candidate will best fit a team, assuming that skills and experience are adequate. A problem with this approach is that selection of team members can be subjective, and not all managers have experience and intuition necessary to make informed decisions.

Traditional approaches to team building can include evaluating objective characteristics for potential candidates, such as performance, learning aptitude, development plan, and compensation requirements. Using traditional approaches can result in assumptions that a team's success is based on a sum of the objective characteristics of the team members.

### SUMMARY

The present disclosure describes techniques for building teams based on personality traits of team members. In an implementation, a computer-implemented method comprises: receiving personality data associated with one or more individuals, wherein the personality data is used to select a candidate from the one or more individuals for placement on a new team associated with a project or to match the candidate to an existing team; receiving performance data for one or more existing teams on one or more existing projects; receiving team preference data identifying an importance value associated with each team aspect of one or more team aspects used in a determination of the new team or for the existing team; and determining, using machine learning and based on the personality data, the performance data, and the team preference data, a new team for the project or an update to the existing team.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. First, teams can be generated based on a balance of personality traits of team members. For example, personality traits can include gender, origin, and, education, or other aspects associated with the team members. Second, teams can be generated based on more than intuitive, subjective information and objective characteristics of team members. Third, under-performing teams can be identified based on areas affected by personality traits of team members. Fourth, initial behavior can be obtained from research, and a learning component can continuously gather information from an organization to improve predictions of which personality types will get along with each other. Fifth, simulations/suggestions can be applied to identify a better matching team member and in order to increase team performance on a desired aspect (for example, quality and agility). Sixth, research and a learning component can be used to continuously gather information from an organization to improve predictions of optimized team size for a specific goal/task. Seventh, improved team productivity and collaboration can result in increasing team member satisfaction, engagement, and productivity, and can reduce attrition. The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram illustrating an example of a system for performing team matching, according to an implementation of the present disclosure.

FIG. 2 is a block diagram illustrating an example of a system for performing team matching optimization, according to an implementation of the present disclosure.

FIG. 3 is a block diagram illustrating examples of a personality traits plot and a personality trait averages chart, according to an implementation of the present disclosure.

FIG. 4 is a screen shot of an example display of a team builder application (app), according to an implementation of the present disclosure.

FIG. 5 is a screen shot of an example display of the team builder app, according to an implementation of the present disclosure.

FIG. 6 is a screen shot of an example display of the team builder app, according to an implementation of the present disclosure.

FIG. 7 is a screen shot of an example display of the team builder app, according to an implementation of the present disclosure.

FIG. 8 is a screen shot of an example display of the team builder app, according to an implementation of the present disclosure.

FIG. 9 is a screen shot of an example display of the team builder app, according to an implementation of the present disclosure.

FIG. 10 is a block diagram illustrating an example of relationships in an architecture between an employee node and personality nodes, according to an implementation of the present disclosure.

FIG. 11 is a block diagram illustrating an example of relationships in an architecture among nodes, according to an implementation of the present disclosure.

FIG. 12 is a flowchart illustrating an example of a computer-implemented method for building teams based on personality traits of team members, according to an implementation of the present disclosure.

FIG. 13 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes techniques for building teams based on personality traits of team members, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Team synergy and personality matches are an important part in building successful teams with high productivity, deliverables quality, and motivation. Combining the right people to create a successful team can be done by a manager based on their experience, judgement, and intuition. New team members can be recruited from inside of or from outside of an organization. Contractors can be hired to join the team for a limited time. Teams can be built from scratch.

A candidate for a team may have the right skills for a suitable role, but based on personality, may be erroneously assigned to a team. This can result in low motivation, high attrition, low employment engagement, and low performance. Existing team structures that do not consider personality can be sub-optimal, such as having low efficiency and productivity.

In some implementations, a team can be measured by its synergy, using personality traits that affect the team. For example, personality assessments can be run on each team member, including existing team members and candidate team members. The assessments can provide, for example, team-level insights, including team synergies, team dynamics, and quirks of individual team members. The assessments can provide, for example, an evaluation regarding how a new team member or a candidate (either internal or external to an organization) will likely mesh with and influence the team.

In some implementations, team-matching tools can provide team-related dashboards. Using the dashboards, a manager can view their different teams and team-related measures such as performance, deliverables quality, motivation, and team spirit. The dashboards can provide a view into the personality profile of each team member. The manager can receive insights on the interactions between team members and insights on each team's strengths and weaknesses. Managers can use tools available through the dashboards to check potential matches of new people to new or existing teams

Each team member can complete a personality assessment. Team members can be allowed to view information at a team level, including a full team map, and insights and recommendations regarding the team's strengths and weaknesses. Predictions can be provided regarding the harmony and synergies among possible team members and within teams.

In some implementations, personality information for each team member can be based on a personality assessment that uses a Myers-Briggs Type Indicator (MBTI) model, other personality psychological models, or a combination of models. Personality information that is collected can be used to perform team effectiveness assessments and generate team insights. The assessments can be based on expert analysis of existing academic research, validated insights from gathered data, and predictions based on machine learning techniques.

In some implementations, a structured decision-support tool can be used by managers. The tool can be used to collect personality assessments for the team members, for example, from questionnaires and public information. The tool can then build a team profile and provide the manager with visibility regarding each team member's personality and preferences. The tool can also measure or predict a team's effectiveness based on, for example, 1) the manager's estimation of effectiveness; 2) team members' estimations of success; 3) questionnaires completed by managers and team members; and 4) information from organizational systems.

Using available information, the tool can provide team recommendations based on predicted personality clashes or synergies that can occur among team members. The recommendations can use machine learning and big data and be based on existing psychological research and patterns of successful teams.

The tool can provide various visual features that can be used by managers. For example, a simulation can simulate team productivity based on changes in adding person X to the team, replacing person Y with person X, comparing other possible candidates' impact on the team, promoting a team member, and switching roles between team members. The tool can be based on up-to-date information that is collected, for example, from periodic personality assessments. The tool can enable each team member a view a completed team map. Views that are available to team members can adhere to data privacy standards, allowing people to be the owners of their personal information and permit or prohibit access by others. Access to information can be designated at levels that include, for example, team access, manager access, and organizational access. Information can be designated as information associated with the person's name, anonymized information, or designating that no information is to be shared.

Teams can be designated for different parts of a project lifecycle, as different teams can be more suitable for particular stages of a project for example, in project initialization, team member availability dates, project ramp-up, project fast-speed activities (for example, prototyping), and project maintenance. Team structure and balance can be changed over the lifetime of the project to meet the requirements of each project period. Team assessments can be different depending on the members of a team.

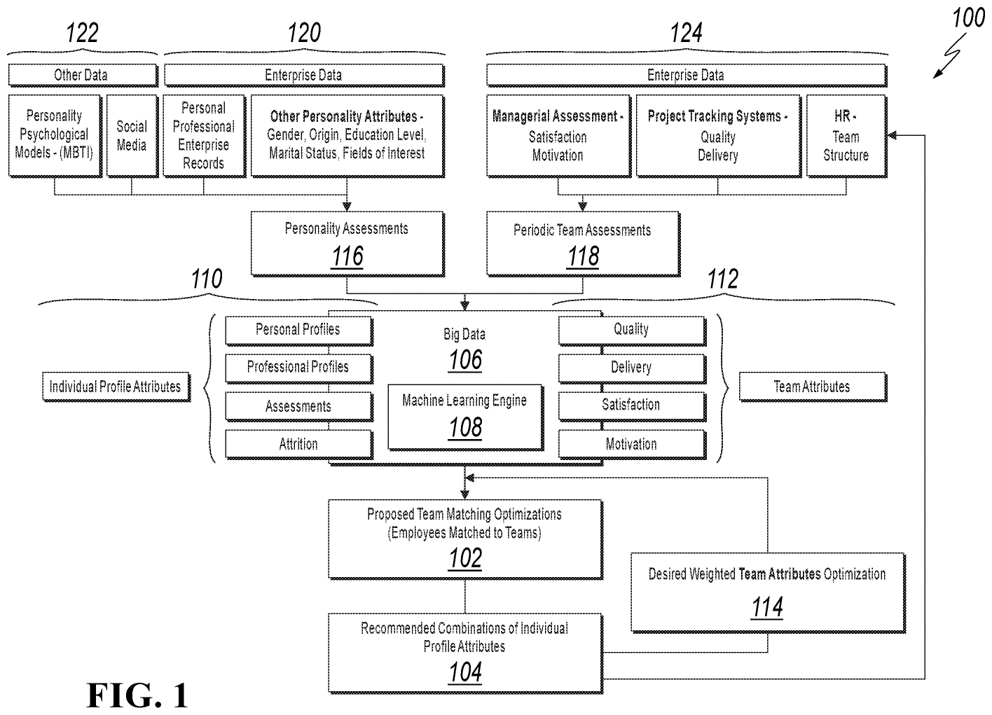

FIG. 1 is a block diagram illustrating an example of a system 100 for performing team matching, according to an implementation of the present disclosure. The system 100 can produce proposed team matching optimizations 102 in which employees, for example, are matched to teams. The proposed team matching optimizations 102 can generate recommended combinations of individual profile attributes 104.

Proposed team matching optimizations 102 can be created using big data 106 and a machine learning engine 108. The big data 106 can include individual profile attributes 110 (for example, personal profiles, professional profiles, assessments, and attrition information) and team attributes 112 (for example, metrics or measures of quality, deliverables quality, satisfaction, and motivation). Managers can perform desired weight team attributes optimizing 114, for example, by weighting or ranking individual attributes of the individual profile attributes 110 and the team attributes 112. The big data 106 can be populated, for example, using personality assessments 116 and periodic team assessments 118.

The personality assessments 116 can be generated using enterprise data 120 and other data 122. The enterprise data 120 can include personal professional enterprise records and other personality attributes (for example, gender, origin, education level, marital status, and fields of interest). The other data 122 can include, for example, personality and psychological information (for example, from MBTI models) and information from social media.

The periodic team assessments 118 can be generated using enterprise data 124. The enterprise data 124 can include, for example, managerial assessment (including satisfaction and motivation information), project tracking systems (for example, that track quality and delivery), and human resources (HR) information that identifies team structure.

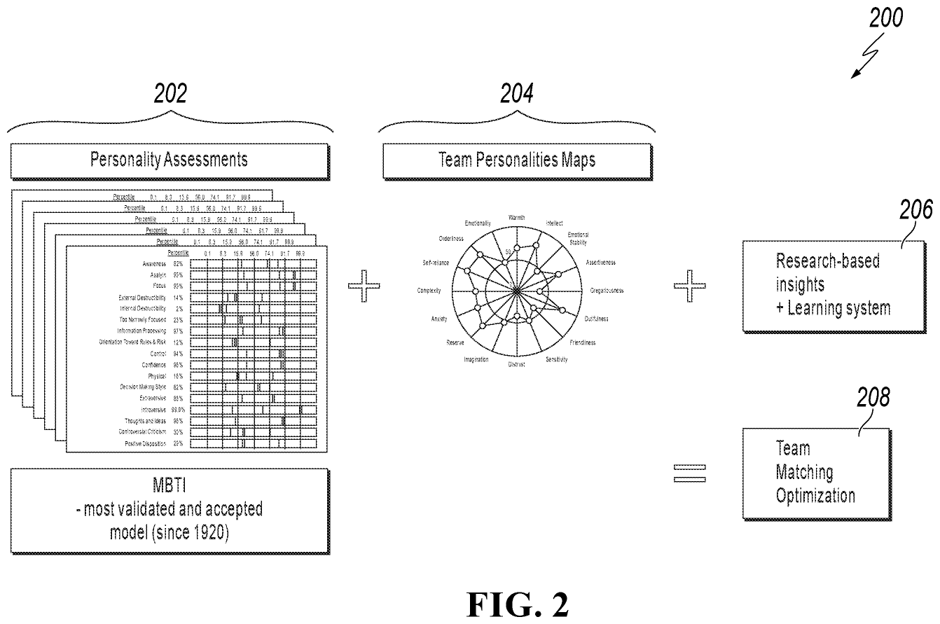

FIG. 2 is a block diagram illustrating an example of a system 200 for performing team matching optimization, according to an implementation of the present disclosure. The system 200 can be or can represent the system 100, for example.

The system 200 can be based on personality assessments 202 (for example, the personality assessments 116) and team personalities maps 204. The personality assessments 202 can include, for each team member (existing or proposed), scores that indicate various personality types of the team member. This information can be captured by the personality assessments 202 and stored in the big data 106 for later use by managers and by processes of the systems 100 and 200. The personality assessments 202 can be used to construct the team personalities maps 204, which can be presented visually to managers who are assessing or modifying existing teams or creating new teams. Research-based insights and a learning system 206 can be combined with the personality assessments 202 and the team personalities maps 204 in order to achieve team matching optimization 208.

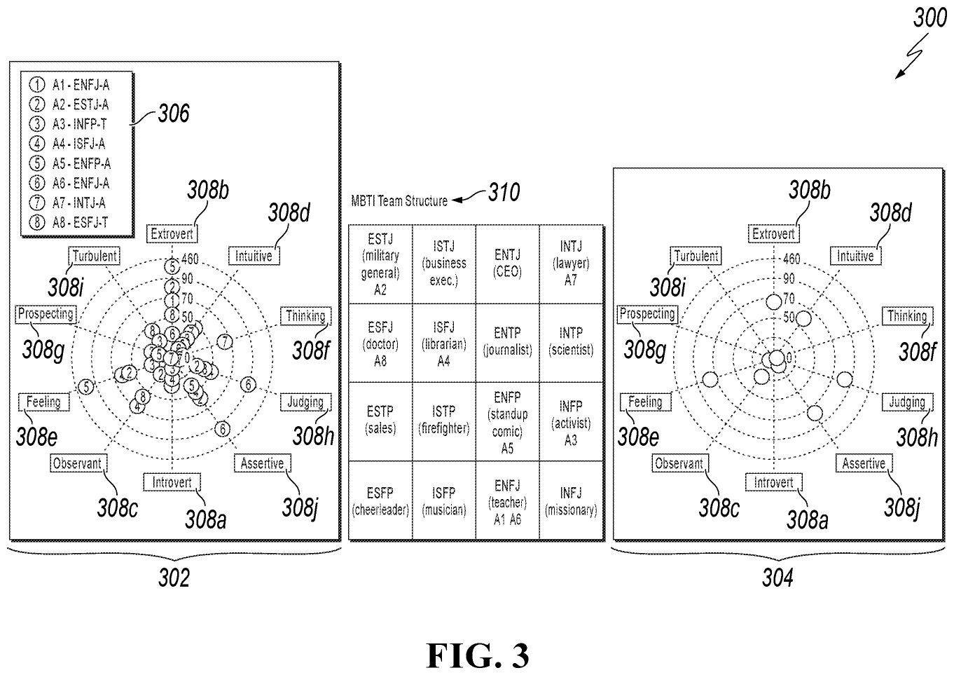

FIG. 3 is a block diagram illustrating examples of a personality traits plot 302 and a personality trait averages chart 304, according to an implementation of the present disclosure. The personality traits plot 302 shows personality relationships among the eight team members identified in a key 306. Locations of numbered circles 1-8, corresponding to the eight team members (that is, “A1” through “A8”), identify a team member's score relative to the MBTI attributes. The attributed include introvert 308a versus extrovert 308b, observant 308c versus intuitive 308d, feeling 308e versus thinking 308f, prospecting 308g versus judging 308h, and turbulent 308i versus assertive 308j. In some implementations, color coding of circles can be used instead of numbered circles to associate plotted circles with corresponding team members listed in the key 306. The eight team members (“A1” through “A8”) are also included in personality type cells an MBTI team structure chart 310. A manager can use the personality traits plot 302 and the MBTI team structure chart 310 to obtain a visual understanding of a distribution of personality types held by the team members. A personality trait averages chart 304 can plot average values along the attributes of the personality attributes 308a-308j. In addition to MBTI-based attributes and team structures, other personality psychological models or a combination of models can be used.

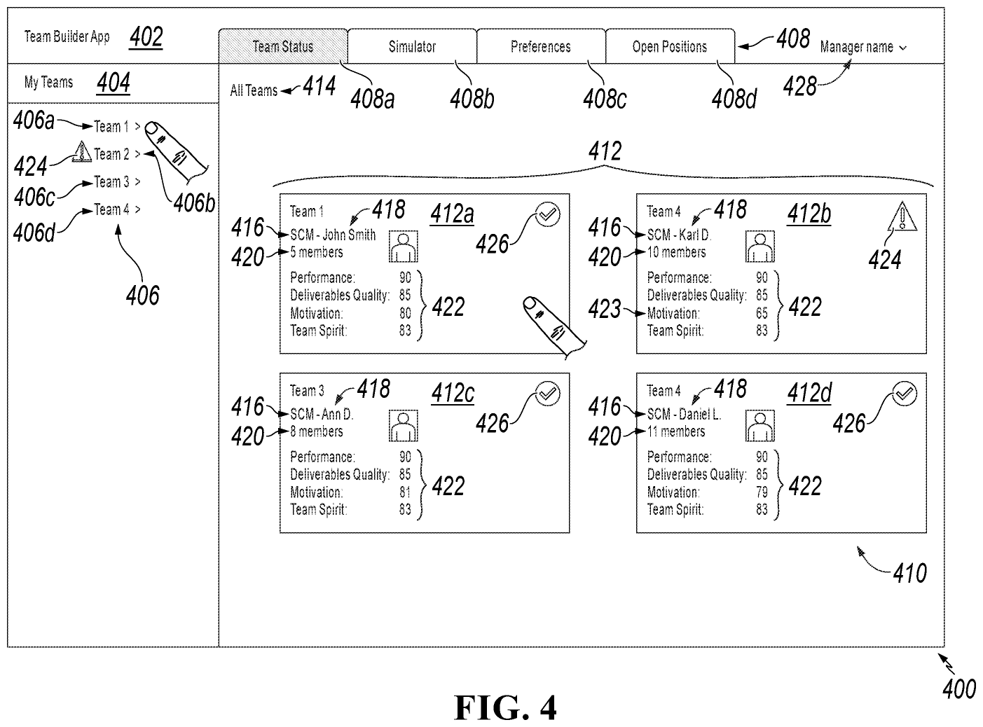

FIG. 4 is a screen shot 400 of an example display of a team builder application (app) 402, according to an implementation of the present disclosure. A user (for example, a manager) can use the team builder app 402, for example, to build teams using information that is displayed about team members, existing teams, and current values of preferences that are to be used by the team builder app 402.

A my teams area 404 can list teams 406 that are available for use by the user in the team builder app 402. Teams that are displayed can be teams that are managed by the user (for example, the manager of the teams). A selection of a particular team 406 can control, at least in part, the information that is displayed by the team builder app 402 in other areas of the screen.

Information that is displayed by the team builder app 402 can depend on a current selection of one of tabs 408. For example, the user can select from among a team status tab 408a, a simulator tab 408b, a preferences tab 408c, and an open positions tab 408d. When the team status tab 408a is selected, as shown in FIG. 4, a team information display area 410 includes team information boxes 412 (412a-412d) corresponding to the teams 406 that are listed in the my teams area 404. A label 414 can indicate that the information being displayed in the team information display area 410 includes, for example, “All Teams” information, corresponding to the current selection of the team status tab 408a. At other times, the label 414 can display other values corresponding to a current selection of the other tabs (for example, the simulator tab 408b, the preferences tab 408c, or the open positions tab 408d).

The team information boxes 412a-412d can each display team information that is specific to the corresponding teams 406a-406d. The team information can include a team type 416 (for example, supply chain manager (SCM)), a team leader name 418 (for example, an SCM manager's name), and a number of members 420 in the team. The team information can also list current values of team-related measures 422 (such as, performance, deliverables quality, motivation, and team spirit).

In some implementations, alerts 424 can be displayed when information regarding a team needs to be flagged for the user. The flagging can occur, for example, whenever a value or some other information related to a team is outside of a normal or preferred range. Normal ranges and other threshold values can be set by the user on a universal basis (for example, all teams) or on a team-by-team basis. For example, when a value of a team-related measure 422 (for example, a team-related motivation measure 423) is lower than desired, then the alerts 424 can appear adjacent to the team name (for example, Team 2) of the team 406b and in the team information box 412b for Team 2. Acceptable value indicators 426 (for example, green check boxes), when displayed in the team information boxes 412a, 412c, and 412d, for example, can indicate that information for a given team is in an acceptable range.

In some implementations, a manager name control 428 can be used by the user to access team information for one or more user-selected manager names. For example, the user can elect to display team information boxes 412 for one or more manager names matching the team leader names 418.

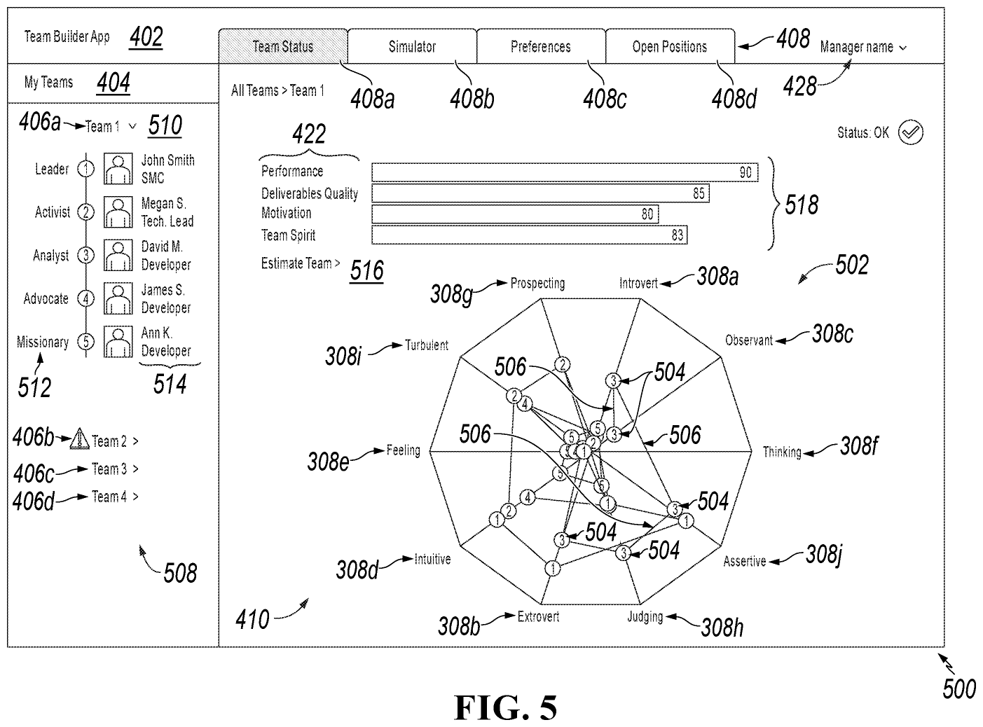

FIG. 5 is a screen shot 500 of an example display of the team builder app 402, according to an implementation of the present disclosure. The team information display area 410 includes a team personality plot 502 that uses points 504 and connecting lines 506 to map team members 514 of the team 406a to personality attributes 308a-308j. For example, the points 504 appearing as circle containing “1” can indicate personality trait plots of the team member 508 John Smith. An expanded listing 510 of the team members 508 in the team 406a includes team roles 512 (for example, leader, activist, analyst, advocate, and missionary) and team member names and positions 514 (for example, SCM, technical lead, and developer). The personality plot 502 is presented in an estimate team area 516 that appears beneath preferences settings 518. The preferences settings 518 can indicate values for the team's team-related measures 422 (performance, deliverables quality, motivation, and team spirit). Preferences settings 518 that can serve as preferences goals for the team can be set through access of the preferences tab 408c.

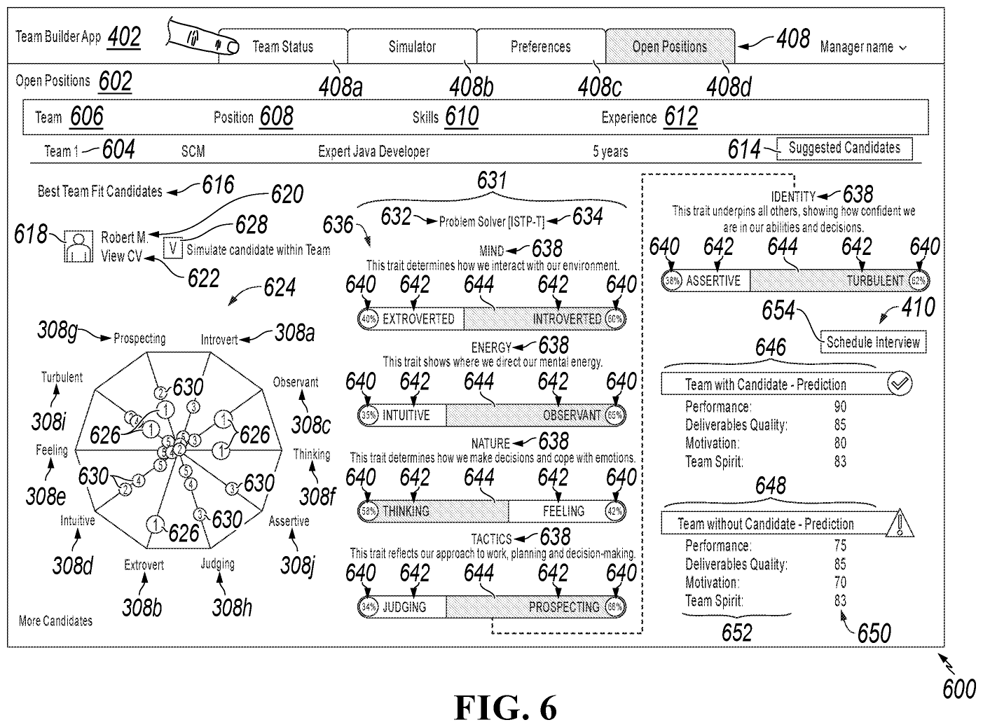

FIG. 6 is a screen shot 600 of an example display of the team builder app 402, according to an implementation of the present disclosure. The example display can be presented, for example, when the open positions tab 408d is selected. In this example, an open positions area 602 is displayed that lists openings 604 by team name 606 (for example, Team 1). Each opening 604 that is displayed can include a position 608, one or more skills 610, and experience 612. A suggest candidates control 614 can be used by the team builder app 402 to perform a personality-based (among other criteria) search among candidates to fill the opening 604.

A Best Team Fit Candidates area 616 can display candidate information for at least one candidate identified for potentially filling the opening 604. An image 618 and a candidate name 620 can be displayed for each candidate. A view CV control 622 can be used to display the candidate's curriculum vitae (CV).

When candidate information for a candidate is initially displayed, a personality traits plot 624 can initially plot circles (indicated in FIG. 6 as large circles 626) representing personality traits of the suggested candidate. Upon selection of a simulate candidate within team control 628, smaller circles 630 can be added to the personality traits plot 624 to plot personality traits of existing members of the team. In some implementations, color coding can be used to associate the displayed smaller circles to particular team members.

A personality type area 631 can be used to display a personality role 632 (for example, problem solver) and a MBTI type 634 (for example, ISTP-T). Some examples of personality types can be Introverted-Sensing-Thinking-Judging (ISTJ) and Extraverted-iNtuitive-Feeling-Perceiving (ENFP). The personality type area 631 can include a bar graph 636 for each of five traits 638 (for example, mind, energy, nature, tactics, and identity). Each bar graph 636 can include a pair of scores 640 totaling 100 percent (%), with the scores 640 indicating percentage scores of opposing trait types 642. Shaded bars 644 can indicate the personality trait of the particular trait 638 having a highest score. For example, the shaded bar 644 for the mind trait 638 can indicate that the candidate is introverted, based on an introverted score or 60% and an extroverted score 640 of 40%. The MBTI type 634 can be, for example, MBTI-based, or other personality psychological models or extended models can be used.

Selection of the simulate candidate within team control 628 can also cause the display of team aspect predictions 646 and 648, corresponding to the team being with the candidate versus without the candidate. Prediction values 650 can be provided for each of the team aspects 652 of performance, deliverables, motivation, and team spirit. Prediction values 650 that are lower for the team without the candidate can be highlighted, for example, using a different text color or font. A schedule interview control 654 can be used to initiate a process of scheduling an interview with the candidate.

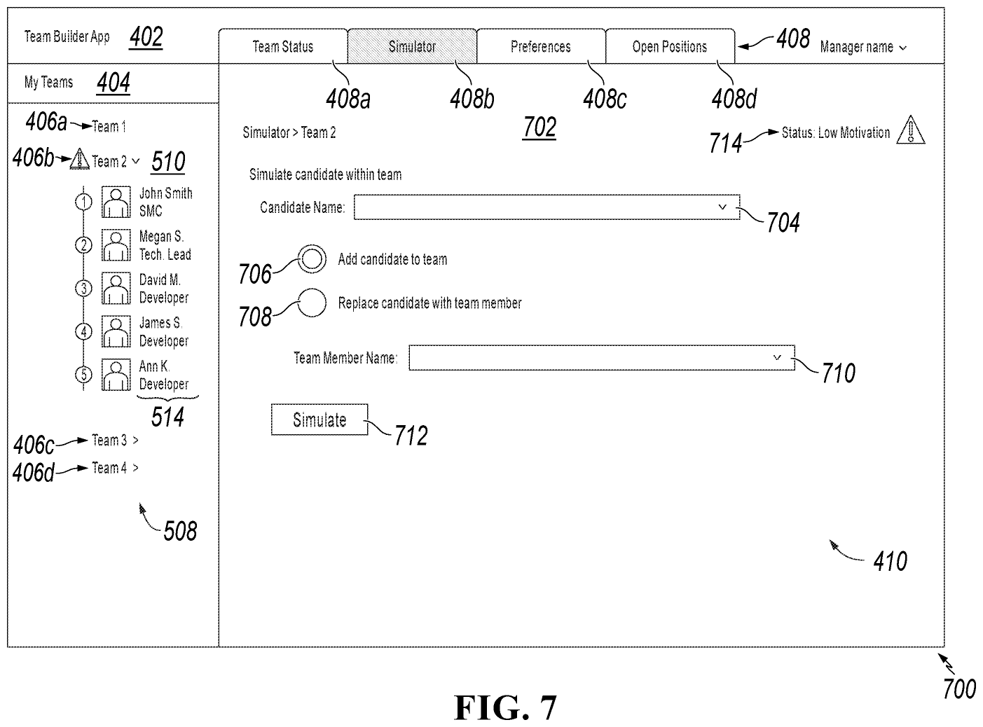

FIG. 7 is a screen shot 700 of an example display of the team builder app 402, according to an implementation of the present disclosure. For example, the user can select the team 406b (for example, Team 2) and select the simulator tab 408b to display a simulator information and controls area 702 for defining inputs to and for executing a simulation. The simulation can be used to provide information regarding the personality make-up of a team and resulting team aspects when a team member is added to, or replaced in, the team.

The user can use a candidate name field 704 to input the name of a potential candidate. By selecting an add control 706 for adding the candidate to the team, the user can program the simulation to use the new candidate specified in the candidate name field 704. By selecting an add control 708 for using the candidate to replace an existing team member, the user can program the simulation to use the new candidate specified in the candidate name field 704 to replace an existing team member identified in a team member name field 710. In some implementations, other controls can exist in the controls area 702 by which the user can initiate other types of simulations, such as to simulate the effects of different existing team members being replaced by the candidate. When the controls are defined for the simulation, the user can select a simulate control 712 to start the simulation. A suggestion to add or replace a team member may be inferred by the user based on a display of a status 714 (for example, low motivation) of a team aspect. Running the simulation can result, for example, in the display of one or more of the team personality plot 502, the personality traits plot 624, and the team aspect predictions 646 and 648.

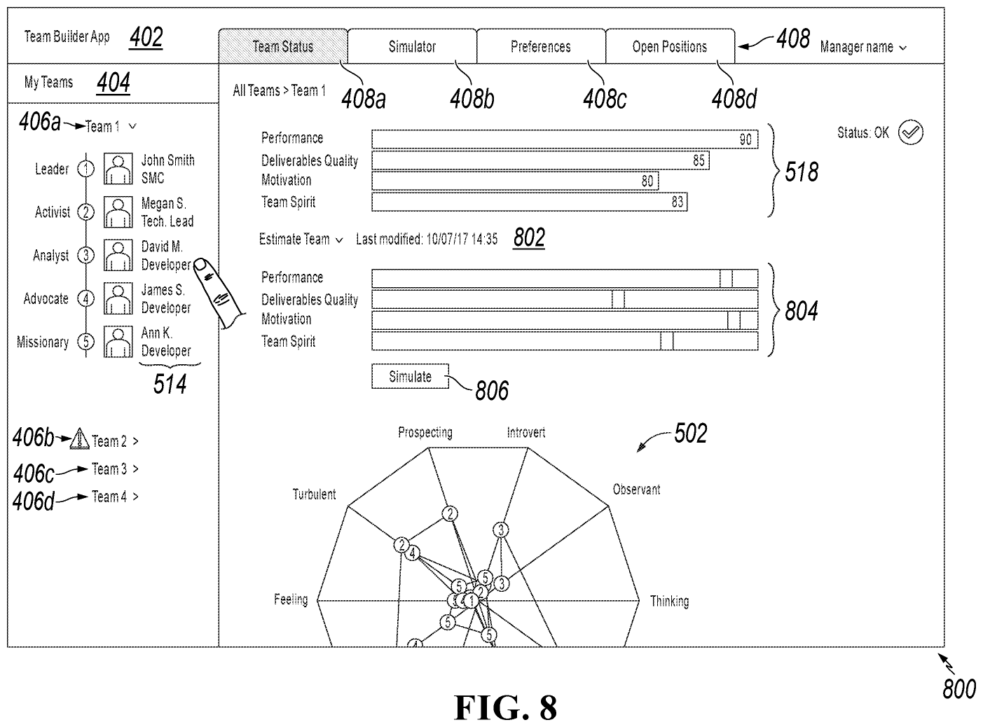

FIG. 8 is a screen shot 800 of an example display of the team builder app 402, according to an implementation of the present disclosure. A team aspects estimation area 802 can be used by the user to submit estimates of team aspects of a given team. Controls 804 can be used to set threshold team aspect levels. A submit control 806 can be used to submit the estimate. A result of submitting the estimate can be a display of the team personality plot 502 for the currently selected team.

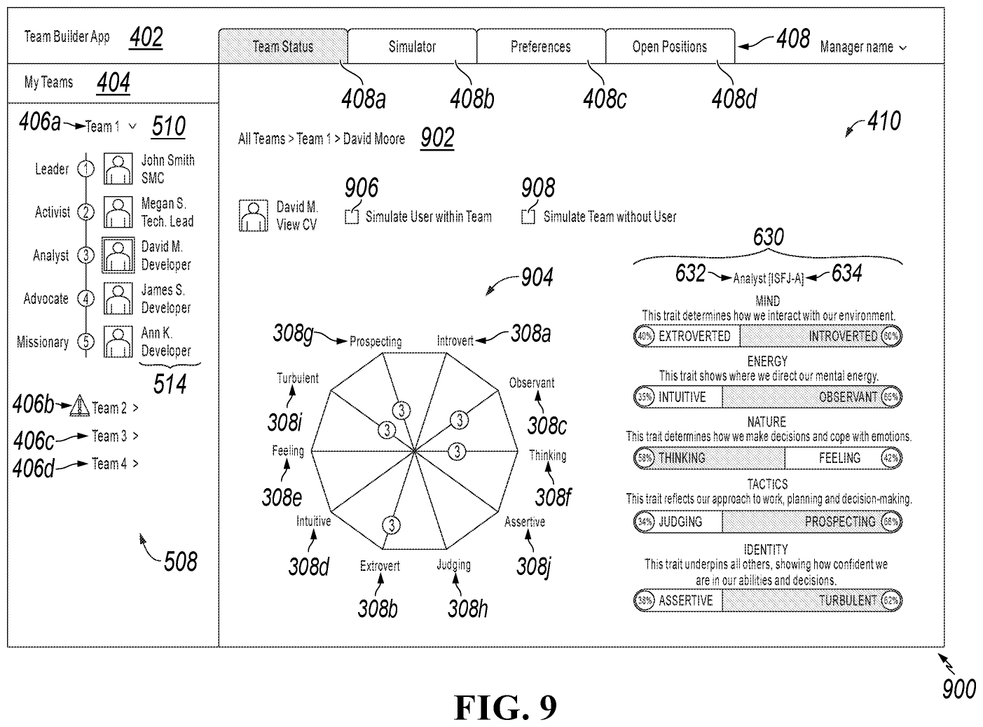

FIG. 9 is a screen shot 900 of an example display of the team builder app 402, according to an implementation of the present disclosure. A team member simulation area 902 for a selected team member 514 (for example David M.) can be displayed. Initially, a personality plot 904 can be presented that plots personality traits for the team member. The personality type area 631 can display the personality role 632 (for example, analyst) and a MBTI type 634 (for example, ISFJ-A) for the team member. The MBTI type 634 can be, for example, MBTI-based, or other personality psychological models or extended models can be used.

Controls 906 and 908 are selectable by the user for running simulations. If the user selects the control 906, for example, the personality plot 904 can be updated with personality traits of the other team members in the team. If the user selects the control 908 for example, the personality plot 904 can be updated with personality traits of the other team members in the team.

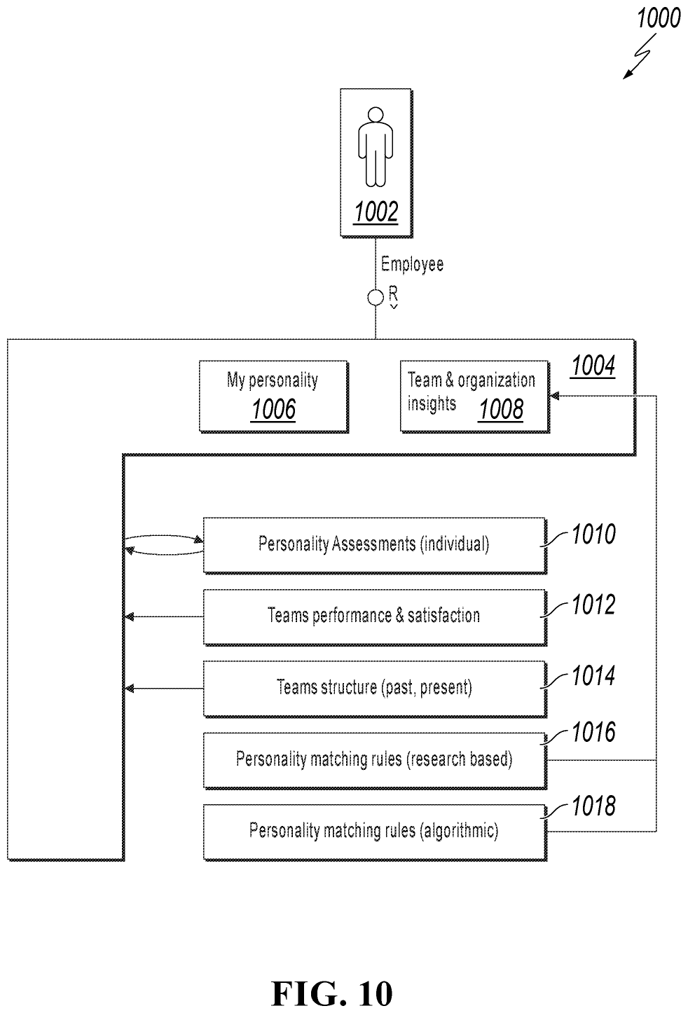

FIG. 10 is a block diagram illustrating an example of relationships in an architecture 1000 between an employee node 1002 and personality nodes 1006 and 1008, according to an implementation of the present disclosure. The employee node 1002 can have relationships, for example, with a my personality node 1006 and a team and organization insights node 1008 in a personality package 1004. The personality package 1004 can receive inputs from (and provide updates to) personality assessments 1010. The personality package 1004 can receive inputs from team performance and satisfaction information 1012 and teams structure 1014. The team and organization insights node 1008 can receive inputs from research-based personality matching rules 1016 and algorithmic personality matching rules 1018.

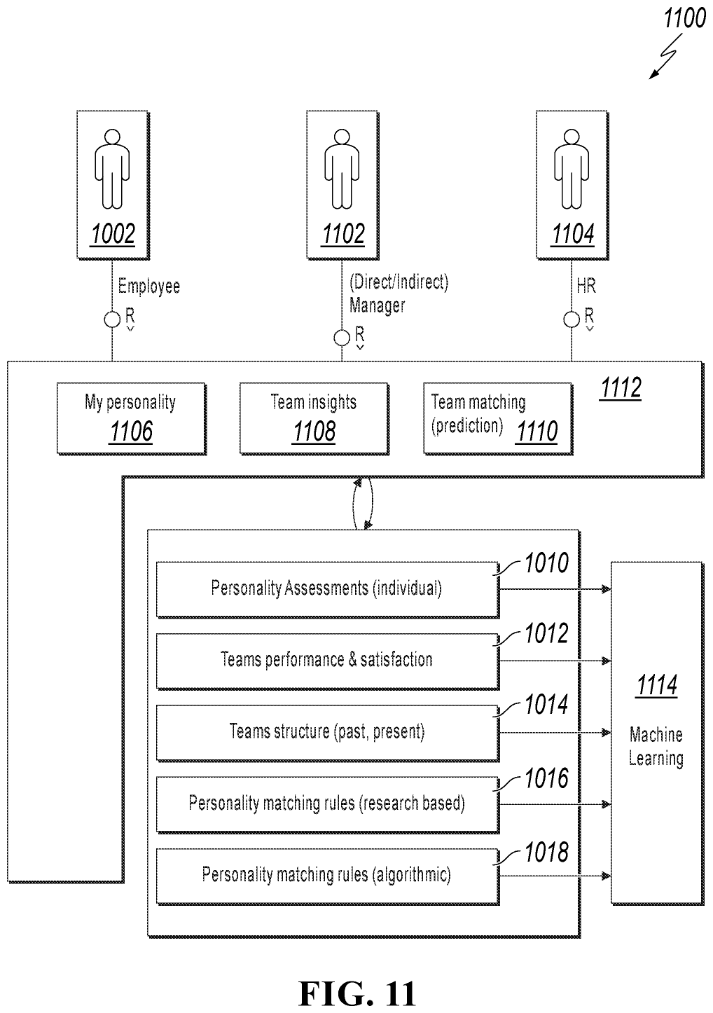

FIG. 11 is a block diagram illustrating an example of relationships in an architecture 1100 among nodes, according to an implementation of the present disclosure. The employee node 1002, a manager node 1102, and an HR node 1104 can interact with a team personality package 1112 that includes my personality node 1106 and a team insights node 1108 and a team matching node 1110. The team personality package 1112 can interface with the personality assessments 1010, the team performance and satisfaction information 1012, the teams structure 1014, the researched-based personality matching rules 1016, and the algorithmic personality matching rules 1018. A machine learning module 1114 can receive inputs from the personality assessments 1010, the team performance and satisfaction information 1012, the teams structure 1014, and the research-based personality matching rules 1016. The machine learning module 1114 can provide outputs to the algorithmic personality matching rules 1018.

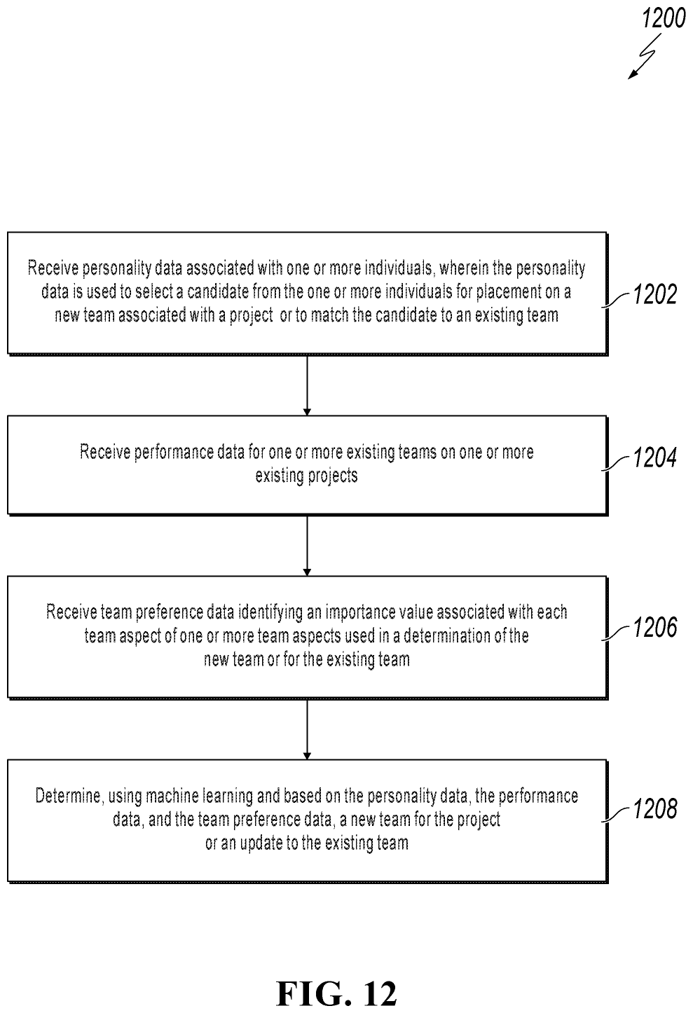

FIG. 12 is a flowchart illustrating an example of a computer-implemented method 1200 for building teams based on personality traits of team members, according to an implementation of the present disclosure. For clarity of presentation, the description that follows generally describes method 1200 in the context of the other figures in this description. However, it will be understood that method 1200 can be performed, for example, by any system, environment, software, and hardware, or a combination of systems, environments, software, and hardware, as appropriate. In some implementations, various steps of method 1200 can be run in parallel, in combination, in loops, or in any order.

Method 1200 can be used to build a new team or to match candidates to an existing team. For example, method 1200 can be used to make predictions regarding matching candidate to a new or existing team, recommend candidates who are the best fit for replacing team members of an existing team, adding new members to an existing team, and building a new team.

At 1202, personality data associated with one or more individuals is received. The personality data is used to select a candidate from the one or more individuals for placement on a new team associated with a project or to match the candidate to an existing team. For example, the personality data for the one or more individuals can include at least one of personal profile information, professional profile information, assessment information, or attrition information. The team builder app 402, for example, can receive personality information for team members from the big data 106. From 1202, method 1200 proceeds to 1204.

At 1204, performance data for one or more existing teams on one or more existing projects is received. The team builder app 402, for example, can receive information from the period team assessments 118 including, for example, metrics or measures of quality, deliverables quality, satisfaction, and motivation. From 1204, method 1200 proceeds to 1206.

At 1206, team preference data is received that identifies an importance value associated with each team aspect of one or more team aspects used in a determination of the new team or for the existing team. For example, the team builder app 402 can receive the team attributes 112. The one or more team aspects can include data specifying at least one of performance, deliverables, motivation, or team spirit. In some implementations, the one or more team aspects further include data specifying team member interactions and team strengths/weaknesses. From 1206, method 1200 proceeds to 1208.

At 1208, a new team for the project (or an update to the existing team) is determined using machine learning and based on the personality data, the performance data, and the team preference data. As an example, the team builder app 402 can generate a new team. The new team can include team members that are selected based on personality. In some implementations, the user can use suggested candidates provided by the team builder app 402 to create a new team or change an existing team. After 1208, method 1200 stops.

In some implementations, method 1200 can also include performing a personality assessment for the one or more individuals using at least one of personality psychological models, social media information, personal professional enterprise records, or individual-provided profile information.

In some implementations, method 1200 can also include performing periodic team assessments using at least one of managerial assessment data, project tracking data, or human resources data.

In some implementations, method 1200 can also include calculating a prediction of harmony and synergy values for the candidate with respect to the new team or the existing team.

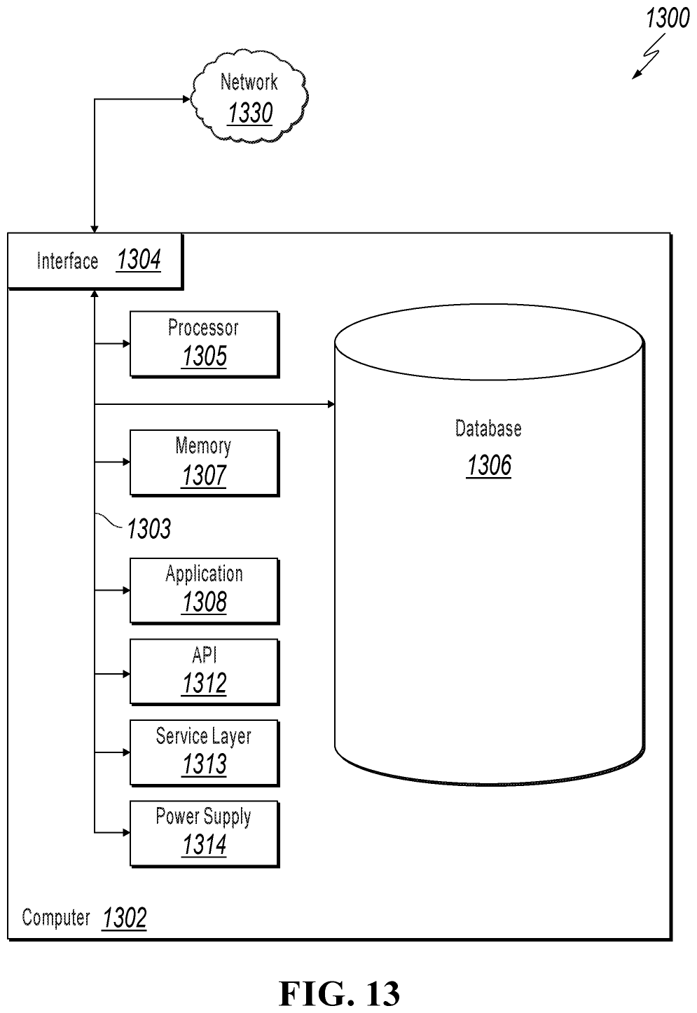

FIG. 13 is a block diagram illustrating an example of a computer-implemented System 1300 used to provide computational functionalities associated with described algorithms, methods, functions, processes, flows, and procedures, according to an implementation of the present disclosure. In the illustrated implementation, System 1300 includes a Computer 1302 and a Network 1330.

The illustrated Computer 1302 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 1302 can include an input device, such as a keypad, keyboard, or touch screen, or a combination of input devices that can accept user information, and an output device that conveys information associated with the operation of the Computer 1302, including digital data, visual, audio, another type of information, or a combination of types of information, on a graphical-type user interface (UI) (or GUI) or other UI.

The Computer 1302 can serve in a role in a distributed computing system as, for example, a client, network component, a server, or a database or another persistency, or a combination of roles for performing the subject matter described in the present disclosure. The illustrated Computer 1302 is communicably coupled with a Network 1330. In some implementations, one or more components of the Computer 1302 can be configured to operate within an environment, or a combination of environments, including cloud-computing, local, or global.

At a high level, the Computer 1302 is an electronic computing device operable to receive, transmit, process, store, or manage data and information associated with the described subject matter. According to some implementations, the Computer 1302 can also include or be communicably coupled with a server, such as an application server, email server, web server, caching server, or streaming data server, or a combination of servers.

The Computer 1302 can receive requests over Network 1330 (for example, from a client software application executing on another Computer 1302) and respond to the received requests by processing the received requests using a software application or a combination of software applications. In addition, requests can also be sent to the Computer 1302 from internal users (for example, from a command console or by another internal access method), external or third-parties, or other entities, individuals, systems, or computers.

Each of the components of the Computer 1302 can communicate using a System Bus 1303. In some implementations, any or all of the components of the Computer 1302, including hardware, software, or a combination of hardware and software, can interface over the System Bus 1303 using an application programming interface (API) 1312, a Service Layer 1313, or a combination of the API 1312 and Service Layer 1313. The API 1312 can include specifications for routines, data structures, and object classes. The API 1312 can be either computer-language independent or dependent and refer to a complete interface, a single function, or even a set of APIs. The Service Layer 1313 provides software services to the Computer 1302 or other components (whether illustrated or not) that are communicably coupled to the Computer 1302. The functionality of the Computer 1302 can be accessible for all service consumers using the Service Layer 1313. Software services, such as those provided by the Service Layer 1313, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 1302, alternative implementations can illustrate the API 1312 or the Service Layer 1313 as stand-alone components in relation to other components of the Computer 1302 or other components (whether illustrated or not) that are communicably coupled to the Computer 1302. Moreover, any or all parts of the API 1312 or the Service Layer 1313 can be implemented as a child or a sub-module of another software module, enterprise application, or hardware module without departing from the scope of the present disclosure.

The Computer 1302 includes an Interface 1304. Although illustrated as a single Interface 1304, two or more Interfaces 1304 can be used according to particular needs, desires, or particular implementations of the Computer 1302. The Interface 1304 is used by the Computer 1302 for communicating with another computing system (whether illustrated or not) that is communicatively linked to the Network 1330 in a distributed environment. Generally, the Interface 1304 is operable to communicate with the Network 1330 and includes logic encoded in software, hardware, or a combination of software and hardware. More specifically, the Interface 1304 can include software supporting one or more communication protocols associated with communications such that the Network 1330 or hardware of Interface 1304 is operable to communicate physical signals within and outside of the illustrated Computer 1302.

The Computer 1302 includes a Processor 1305. Although illustrated as a single Processor 1305, two or more Processors 1305 can be used according to particular needs, desires, or particular implementations of the Computer 1302. Generally, the Processor 1305 executes instructions and manipulates data to perform the operations of the Computer 1302 and any algorithms, methods, functions, processes, flows, and procedures as described in the present disclosure.

The Computer 1302 also includes a Database 1306 that can hold data for the Computer 1302, another component communicatively linked to the Network 1330 (whether illustrated or not), or a combination of the Computer 1302 and another component. For example, Database 1306 can be an in-memory or conventional database storing data consistent with the present disclosure. In some implementations, Database 1306 can be a combination of two or more different database types (for example, a hybrid in-memory and conventional database) according to particular needs, desires, or particular implementations of the Computer 1302 and the described functionality. Although illustrated as a single Database 1306, two or more databases of similar or differing types can be used according to particular needs, desires, or particular implementations of the Computer 1302 and the described functionality. While Database 1306 is illustrated as an integral component of the Computer 1302, in alternative implementations, Database 1306 can be external to the Computer 1302.

The Computer 1302 also includes a Memory 1307 that can hold data for the Computer 1302, another component or components communicatively linked to the Network 1330 (whether illustrated or not), or a combination of the Computer 1302 and another component. Memory 1307 can store any data consistent with the present disclosure. In some implementations, Memory 1307 can be a combination of two or more different types of memory (for example, a combination of semiconductor and magnetic storage) according to particular needs, desires, or particular implementations of the Computer 1302 and the described functionality. Although illustrated as a single Memory 1307, two or more Memories 1307 or similar or differing types can be used according to particular needs, desires, or particular implementations of the Computer 1302 and the described functionality. While Memory 1307 is illustrated as an integral component of the Computer 1302, in alternative implementations, Memory 1307 can be external to the Computer 1302.

The Application 1308 is an algorithmic software engine providing functionality according to particular needs, desires, or particular implementations of the Computer 1302, particularly with respect to functionality described in the present disclosure. For example, Application 1308 can serve as one or more components, modules, or applications. Further, although illustrated as a single Application 1308, the Application 1308 can be implemented as multiple Applications 1308 on the Computer 1302. In addition, although illustrated as integral to the Computer 1302, in alternative implementations, the Application 1308 can be external to the Computer 1302.

The Computer 1302 can also include a Power Supply 1314 The Power Supply 1314 can include a rechargeable or non-rechargeable battery that can be configured to be either user- or non-user-replaceable In some implementations, the Power Supply 1314 can include power-conversion or management circuits (including recharging, standby, or another power management functionality). In some implementations, the Power Supply 1314 can include a power plug to allow the Computer 1302 to be plugged into a wall socket or another power source to, for example, power the Computer 1302 or recharge a rechargeable battery.

There can be any number of Computers 1302 associated with, or external to, a computer system containing Computer 1302, each Computer 1302 communicating over Network 1330. Further, the term “client,” “user,” or other appropriate terminology can be used interchangeably, as appropriate, without departing from the scope of the present disclosure. Moreover, the present disclosure contemplates that many users can use one Computer 1302, or that one user can use multiple computers 1302.

Described implementations of the subject matter can include one or more features, alone or in combination.

For example, in a first implementation, a computer-implemented method comprises: receiving personality data associated with one or more individuals, wherein the personality data is used to select a candidate from the one or more individuals for placement on a new team associated with a project or to match the candidate to an existing team; receiving performance data for one or more existing teams on one or more existing projects; receiving team preference data identifying an importance value associated with each team aspect of one or more team aspects used in a determination of the new team or for the existing team; and determining, using machine learning and based on the personality data, the performance data, and the team preference data, a new team for the project or an update to the existing team.

The foregoing and other described implementations can each, optionally, include one or more of the following features:

A first feature, combinable with any of the following features, wherein the one or more team aspects include data specifying at least one of performance, deliverables, motivation, or team spirit.

A second feature, combinable with any of the previous or following features, wherein the one or more team aspects further include data specifying team member interactions and team strengths/weaknesses.

A third feature, combinable with any of the previous or following features, wherein the personality data for the one or more individuals includes at least one of personal profile information, professional profile information, assessment information, or attrition information.

A fourth feature, combinable with any of the previous or following features, further comprising performing a personality assessment for the one or more individuals using at least one of personality psychological models, social media information, personal professional enterprise records, or individual-provided profile information.

A fifth feature, combinable with any of the previous or following features, further comprising performing periodic team assessments using at least one of managerial assessment data, project tracking data, or human resources data.

A sixth feature, combinable with any of the previous or following features, further comprising calculating a prediction of harmony and synergy values for the candidate with respect to the new team or the existing team.

In a second implementation, a non-transitory, computer-readable medium storing one or more instructions executable by a computer system to perform operations comprising: receiving personality data associated with one or more individuals, wherein the personality data is used to select a candidate from the one or more individuals for placement on a new team associated with a project or to match the candidate to an existing team; receiving performance data for one or more existing teams on one or more existing projects; receiving team preference data identifying an importance value associated with each team aspect of one or more team aspects used in a determination of the new team or for the existing team; and determining, using machine learning and based on the personality data, the performance data, and the team preference data, a new team for the project or an update to the existing team.

The foregoing and other described implementations can each, optionally, include one or more of the following features:

A first feature, combinable with any of the following features, wherein the one or more team aspects include data specifying at least one of performance, deliverables, motivation, or team spirit.

A second feature, combinable with any of the previous or following features, wherein the one or more team aspects further include data specifying team member interactions and team strengths/weaknesses.

A third feature, combinable with any of the previous or following features, wherein the personality data for the one or more individuals includes at least one of personal profile information, professional profile information, assessment information, or attrition information.

A fourth feature, combinable with any of the previous or following features, the operations further comprising performing a personality assessment for the one or more individuals using at least one of personality psychological models, social media information, personal professional enterprise records, or individual-provided profile information.

A fifth feature, combinable with any of the previous or following features, the operations further comprising performing periodic team assessments using at least one of managerial assessment data, project tracking data, or human resources data.

A sixth feature, combinable with any of the previous or following features, the operations further comprising calculating a prediction of harmony and synergy values for the candidate with respect to the new team or the existing team.

In a third implementation, computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: receiving personality data associated with one or more individuals, wherein the personality data is used to select a candidate from the one or more individuals for placement on a new team associated with a project or to match the candidate to an existing team; receiving performance data for one or more existing teams on one or more existing projects; receiving team preference data identifying an importance value associated with each team aspect of one or more team aspects used in a determination of the new team or for the existing team; and determining, using machine learning and based on the personality data, the performance data, and the team preference data, a new team for the project or an update to the existing team.

The foregoing and other described implementations can each, optionally, include one or more of the following features:

A first feature, combinable with any of the following features, wherein the one or more team aspects include data specifying at least one of performance, deliverables, motivation, or team spirit.

A second feature, combinable with any of the previous or following features, wherein the one or more team aspects further include data specifying team member interactions and team strengths/weaknesses.

A third feature, combinable with any of the previous or following features, wherein the personality data for the one or more individuals includes at least one of personal profile information, professional profile information, assessment information, or attrition information.

A fourth feature, combinable with any of the previous or following features, the operations further comprising performing a personality assessment for the one or more individuals using at least one of personality psychological models, social media information, personal professional enterprise records, or individual-provided profile information.

A fifth feature, combinable with any of the previous or following features, the operations further comprising performing periodic team assessments using at least one of managerial assessment data, project tracking data, or human resources data.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
receiving personality data associated with one or more individuals, wherein the personality data is used to select a candidate from the one or more individuals for placement on a new team associated with a project or to match the candidate to an existing team;
receiving performance data for one or more existing teams on one or more existing projects;
receiving team preference data identifying an importance value associated with each team aspect of one or more team aspects used in a determination of the new team or for the existing team; and
determining, using machine learning and based on the personality data, the performance data, and the team preference data, a new team for the project or an update to the existing team.

2. The computer-implemented method of claim 1, wherein the one or more team aspects include data specifying at least one of performance, deliverables, motivation, or team spirit.

3. The computer-implemented method of claim 1, wherein the one or more team aspects further include data specifying team member interactions and team strengths/weaknesses.

4. The computer-implemented method of claim 1, wherein the personality data for the one or more individuals includes at least one of personal profile information, professional profile information, assessment information, or attrition information.

5. The computer-implemented method of claim 4, further comprising performing a personality assessment for the one or more individuals using at least one of personality psychological models, social media information, personal professional enterprise records, or individual-provided profile information.

6. The computer-implemented method of claim 1, further comprising performing periodic team assessments using at least one of managerial assessment data, project tracking data, or human resources data.

7. The computer-implemented method of claim 1, further comprising calculating a prediction of harmony and synergy values for the candidate with respect to the new team or the existing team.

8. A non-transitory, computer-readable medium storing one or more instructions executable by a computer system to perform operations comprising:
receiving personality data associated with one or more individuals, wherein the personality data is used to select a candidate from the one or more individuals for placement on a new team associated with a project or to match the candidate to an existing team;
receiving performance data for one or more existing teams on one or more existing projects;
receiving team preference data identifying an importance value associated with each team aspect of one or more team aspects used in a determination of the new team or for the existing team; and
determining, using machine learning and based on the personality data, the performance data, and the team preference data, a new team for the project or an update to the existing team.

9. The non-transitory, computer-readable medium of claim 8, wherein the one or more team aspects include data specifying at least one of performance, deliverables, motivation, or team spirit.

10. The non-transitory, computer-readable medium of claim 8, wherein the one or more team aspects further include data specifying team member interactions and team strengths/weaknesses.

11. The non-transitory, computer-readable medium of claim 8, wherein the personality data for the one or more individuals includes at least one of personal profile information, professional profile information, assessment information, or attrition information.

12. The non-transitory, computer-readable medium of claim 11, the operations further comprising performing a personality assessment for the one or more individuals using at least one of personality psychological models, social media information, personal professional enterprise records, or individual-provided profile information.

13. The non-transitory, computer-readable medium of claim 8, the operations further comprising performing periodic team assessments using at least one of managerial assessment data, project tracking data, or human resources data.

14. The non-transitory, computer-readable medium of claim 8, the operations further comprising calculating a prediction of harmony and synergy values for the candidate with respect to the new team or the existing team.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving personality data associated with one or more individuals, wherein the personality data is used to select a candidate from the one or more individuals for placement on a new team associated with a project or to match the candidate to an existing team;
receiving performance data for one or more existing teams on one or more existing projects;
receiving team preference data identifying an importance value associated with each team aspect of one or more team aspects used in a determination of the new team or for the existing team; and
determining, using machine learning and based on the personality data, the performance data, and the team preference data, a new team for the project or an update to the existing team.

16. The computer-implemented system of claim 15, wherein the one or more team aspects include data specifying at least one of performance, deliverables, motivation, or team spirit.

17. The computer-implemented system of claim 15, wherein the one or more team aspects further include data specifying team member interactions and team strengths/weaknesses.

18. The computer-implemented system of claim 15, wherein the personality data for the one or more individuals includes at least one of personal profile information, professional profile information, assessment information, or attrition information.

19. The computer-implemented system of claim 18, the operations further comprising performing a personality assessment for the one or more individuals using at least one of personality psychological models, social media information, personal professional enterprise records, or individual-provided profile information.

20. The computer-implemented system of claim 15, the operations further comprising performing periodic team assessments using at least one of managerial assessment data, project tracking data, or human resources data.
